(19) United States
(12) Patent Application Publication
(10) Pub. No.: US 2025/0105892 A1
(43) Pub. Date: Mar. 27, 2025

(54) METHOD AND APPARATUS FOR BEAM MANAGEMENT IN A WIRELESS COMMUNICATION SYSTEM

(71) Applicant: Samsung Electronics Co., Ltd., Gyeonggi-do (KR)

(72) Inventors: Changsung LEE, Gyeonggi-do (KR); Byonghyo SHIM, Seoul (KR); Hyunsoo KIM, Seoul (KR); Yongsuk BYUN, Seoul (KR)

(73) Assignee: Seoul National University R&DB Foundation, Seoul (KR)

(21) Appl. No.: 18/893,582

(22) Filed: Sep. 23, 2024

(30) Foreign Application Priority Data
Sep. 26, 2023 (KR) 10-2023-0129574

(51) Int. Cl. H04B 7/06; H04W 64/00

(52) U.S. Cl. CPC H04B 7/0617; H04W 64/00

(57) ABSTRACT

The present disclosure relates to a 5G communication system or a 6G communication system for supporting higher data rates beyond a 4G communication system such as long term evolution (LTE). A method and apparatus in the wireless communication system includes detecting at least one first object including at least one user equipment (UE), transmitting, to a second base station (BS), a first message including sensing information of the at least one first object, receiving, as response to the first message, from the second BS, a second message including sensing information of at least one second object, identifying the at least one UE based on the at least one first object and the at least one second object, estimating a location of the identified at least one UE, determining a beamforming vector based on the estimated location, and transmitting data, to the at least one UE, based on the determined beamforming vector.

### CROSS-REFERENCE TO RELATED APPLICATION

This application is based on and claims priority under 35 U.S.C. § 119 to Korean Patent Application No. 10-2023-0129574, filed on Sep. 26, 2023, in the Korean Intellectual Property Office, the disclosure of which is incorporated herein by reference in its entirety.

### BACKGROUND

### 1. Field

The disclosure relates generally to a wireless communication system, and more particularly, to a method and apparatus for beam management using sensing information in the wireless communication system.

### 2. Description of the Related Art

Considering the development of wireless communication from generation to generation, technologies have been developed for services targeting humans, such as voice calls, multimedia services, and data services. Due to the commercialization of 5th-generation (5G) communication systems, it is expected that the number of connected devices will exponentially increase and will be connected to communication networks. Such connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. To provide various services by connecting hundreds of billions of devices and things in the 6th-generation (6G) era, there have been ongoing efforts to develop improved 6G communication systems, which are referred to as beyond-5G systems.

6G communication systems, which are expected to be commercialized around 2030, will have a peak data rate of tera (1,000 giga)-level bits per second (bps) and a radio latency less than 100 microseconds (usec), and thus will be 50 times as fast as 5G communication systems and have the 1/10 radio latency thereof.

To achieve such a high data rate and an ultra-low latency, it has been considered to implement 6G communication systems in a terahertz (THz) band, such as 95 GHz to 3THz bands. It is expected that, due to severe path loss and atmospheric absorption in the THz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. There has been ongoing discussion on new technologies for improving the coverage of THz-band signals, such as metamaterial-based lenses and antennas, orbital angular momentum (OAM), and reconfigurable intelligent surface (RIS).

To improve the spectral efficiency and the overall network performances, the following technologies have been developed for 6G communication systems: a full-duplex technology for enabling an uplink transmission and a downlink transmission to simultaneously use the same frequency resource, a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. Through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will impact the next hyper-connected experience. Particularly, it is expected that services such as truly immersive extended reality (XR), high-fidelity mobile hologram, and digital replica could be provided through 6G communication systems. Services such as remote surgery for security and reliability enhancement, industrial automation, and emergency response will be provided through the 6G communication system such that the technologies could be applied in various fields such as industry, medical care, automobiles, and home appliances.

Wireless communication systems are evolving from early systems that provide voice-oriented services to broadband wireless communication systems that provide high data rates and high quality packet data services such as 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e communication standards.

As a representative example of such a broadband wireless communication system, an LTE system adopts orthogonal frequency division multiplexing (OFDM) for a downlink (DL) and single carrier frequency division multiple access (SC-FDMA) for an uplink (UL). The UL refers to a radio link for a UE or MS to send data or a control signal to an eNode B or BS, and the DL refers to a radio link for a BS to send data or a control signal to a UE or MS. Such a multiple access scheme allocates and operates time-frequency resources for carrying data or control information for respective users not to overlap each other, i.e., to maintain orthogonality, thereby differentiating each user's data or control information.

As a future communication system after the LTE, the 5G communication system needs to freely reflect various demands from users and service providers and thus support services that simultaneously meet the various demands. The services considered for the 5G communication system may include enhanced mobile broadband (eMBB), massive machine type communication (mMTC), ultra reliability low latency communication (URLL), etc.

The eMBB aims to provide more enhanced data rates than the LTE, LTE-A or LTE-Pro may support. For example, in the 5G communication system, the eMBB is required to provide 20 Gbps peak data rate in DL and 10 Gbps peak data rate in UL in terms of a single BS. The 5G communication system may need to provide an increasing user perceived data rate while providing the peak data rate. To satisfy these requirements, enhancement of various technologies for transmission or reception including MIMO transmission technologies may be required in the 5G communication system. While the present LTE uses up to 20 MHz transmission bandwidth in the 2 GHz band for signal transmission, the 5G communication system may use frequency bandwidth wider than 20 MHz in the 3 to 6 GHz band or in the 6 GHz or higher band, thereby satisfying the data rate required by the 5G communication system.

In the 5G communication system, mMTC is considered to support an application service such as an IoT application service.

For the mMTC to provide the IoT efficiently, support for access from massive number of terminals in a cell, enhanced coverage of the terminal, extended battery time, reduction in terminal price, etc., may be required. Because the IoT is equipped in various sensors and devices to provide communication functions, it may be supposed to support a large number of UEs in a cell (e.g., 1,000,000 terminals/km²). Furthermore, a UE supporting the mMTC is more likely to be located in a shadow area, such as a basement of a building, which might not be covered by a cell due to the nature of the service, so the mMTC may require an even larger coverage than expected for other services provided by the 5G communication system. The UE supporting the mMTC needs to be a low-cost terminal, and may require quite a long battery life time such as 10 to 15 years because it is difficult to frequently change the battery of the UE.

The URLLC may be a mission-critical cellular based wireless communication service, which may be used for services used for remote control over robots or machinery, industrial automation, unmanned aerial vehicle, remote health care, emergency alert, etc. Accordingly, communication offered by the URLLC may require very low latency (ultra low latency) and very high reliability. For example, URLLC services may need to satisfy sub-millisecond (less than 0.5 millisecond) air interface latency and simultaneously require a packet error rate equal to or lower than 10-5. Hence, for the URLLC services, the 5G system needs to provide a smaller transmit time interval (TTI) than for other services, and simultaneously requires a design that allocates a wide range of resources for a frequency band to secure reliability of the communication link.

Those three services considered in the aforementioned 5G communication system, i.e., eMBB, URLLC, and mMTC, may be multiplexed and transmitted from a single system. In this case, to meet different requirements for the three services, different transmission or reception schemes and parameters may be used between the services. The mMTC, URLLC, and eMBB are examples of different types of services, and embodiments of the disclosure are not limited to the service types.

As the conventional art is deficient in optimizing beam management, there is a need in the art for improvements in beam management in a wireless communication system.

### SUMMARY

Aspects of the disclosure are to address at least the above-mentioned problems and/or disadvantages and to provide at least the advantages described below.

Accordingly, an aspect of the disclosure is to provide a method, performed by a first base station (BS), for beam management in a wireless communication system includes detecting at least one first object including at least one user equipment (UE); transmitting, to a second BS, a first message including sensing information about the at least one first object; receiving, as a response to the first message, from the second BS, a second message including sensing information about at least one second object; identifying the at least one UE based on the at least one first object and the at least one second object; estimating a location of the identified at least one UE; determining a beamforming vector based on the estimated location; and transmitting data, to the at least one UE, based on the determined beamforming vector.

In accordance with an aspect of the disclosure, a first base station (BS) is provided for managing beams based on sensing information in a wireless communication system, including a transceiver; and at least one processor coupled to the transceiver, wherein the at least one processor is configured to detect at least one first object including at least one user equipment (UE), transmit, to a second BS, a first message including sensing information about the at least one first object, receive, as a response to the first message, from the second BS, a second message including sensing information about at least one second object, identify the at least one UE based on the at least one first object and the at least one second object, estimate a location of the identified at least one UE, determine a beamforming vector based on the estimated location, and transmit data, to the at least one UE, based on the determined beamforming vector.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates configurations of a first base station (BS), a second BS and a user equipment (UE), according to an embodiment;

FIG. 2 illustrates a codebook-based beam management method, according to an embodiment;

FIG. 3 illustrates a beam management method using sensing information, according to an embodiment;

FIG. 4 illustrates a method of transmitting and receiving sensing information, according to an embodiment;

FIG. 5 illustrates a beam management method using sensing information, according to an embodiment;

FIG. 6 illustrates a method of detecting a bounding box, according to an embodiment;

FIG. 7 illustrates a method of extracting visual feature information from a bounding box, according to an embodiment;

FIG. 8 illustrates a method of mapping a bounding box, according to an embodiment;

FIG. 9 illustrates a method of estimating a location of a UE, according to an embodiment;

FIG. 10 illustrates a beam management method using sensing information, according to an embodiment;

FIG. 11 illustrates a beam management method when there is no bounding box to be mapped, according to an embodiment;

FIG. 12 illustrates a beam management method when no bounding box is detected, according to an embodiment; and

FIG. 13 illustrates a beam management method using sensing information, according to an embodiment.

### DETAILED DESCRIPTION

Embodiments of the disclosure will be described with reference to the accompanying drawings. Accordingly, those of ordinary skill in the art will recognize that modifications, equivalents, and/or alternatives on the embodiments described herein can be variously made without departing from the scope and spirit of the disclosure. In addition, descriptions of well-known functions and constructions may be omitted for clarity and conciseness.

The terms used herein are defined by considering functionalities in the disclosure but may vary depending on practices or intentions of users or operators. Accordingly, the terms should be defined based on descriptions throughout this specification.

Embodiments of the disclosure may be embodied in many different forms and should not be construed as limited to the embodiments set forth herein. The embodiments are provided for completeness of the disclosure and will fully convey the scope of the embodiments of the disclosure to those of ordinary skill in the art. Like numbers refer to like elements throughout the specification.

Herein, a component is represented in a singular or plural form. It should be understood, however, that the singular or plural representations are selected appropriately according to the situations presented for convenience of explanation, and the disclosure is not limited to the singular or plural form of the component. The component expressed in the plural form may also imply the singular form, and vice versa.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. The modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a small number of components and modules, or further divided into a larger number of components and modules. Moreover, the components and modules may be implemented to execute one or more central processing units (CPUs) in a device or security multimedia card. In embodiments of the disclosure, the module may include one or more processors.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Embodiments herein may be operated by being combined with one another if necessary. For example, parts of the methods herein may be combined to operate the BS and the UE. Although the embodiments of the disclosure are generally based on 5G or NR systems, modifications to the embodiments of the disclosure, which do not deviate from the scope of the disclosure, may be applicable to other systems such as a long term evolution (LTE) system, an LTE-advanced (LTE-A) system, an LTE-A-Pro system, etc.

Herein, the terms to identify access nodes and referring to network entities, messages, interfaces among network entities, and various types of identification information, are examples for convenience of explanation. Accordingly, the disclosure is not limited to the terms as used herein and may use different terms to refer to the items having the same meaning in a technological sense. For example, a terminal as used herein may refer to a medium access control (MAC) entity in a terminal present in each of a master cell group (MCG) and a secondary cell group (SCG).

Some of the terms and names defined by the 3rd generation partnership project (3GPP) LTE will be used hereinafter. The disclosure is not, however, limited to the terms and definitions, and may equally apply to any systems that conform to other standards.

Herein, a base station is an entity for performing resource allocation for a terminal, and may be at least one of a gNB, an eNB, a Node B, a radio access unit, a base station controller, or a network node. The terminal may include a UE, a mobile station (MS), a cellular phone, a smart phone, a computer, or a multimedia system capable of performing a communication function.

The disclosure may be applied to the 3GPP new radio (NR) (which is the 5G mobile communication standard, and to intelligent services based on 5G communication and IoT related technologies, e.g., smart homes, smart buildings, smart cities, smart cars, connected cars, health care, digital education, smart retail, and security and safety services. The term ‘terminal’ or ‘UE’ may refer not only to a cell phone, an NB-IoT device, and a sensor but also to other wireless communication devices.

Although embodiments of the disclosure will now be focused on an LTE, LTE-A, LTE Pro or 5G (or NR, next generation mobile communication) system, the embodiments may be equally applied to other communication systems with similar technical backgrounds or channel types, and to different communication systems with some modifications such that they do not significantly deviate from the scope of the disclosure when judged by those of ordinary skill in the art.

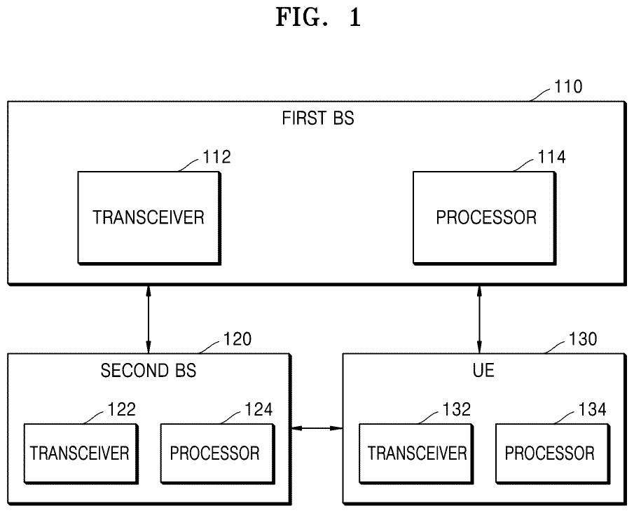

FIG. 1 illustrates configurations of a first BS (110), a second BS (120) and a UE (130), according to an embodiment.

Referring to FIG. 1, the first BS (110) may include a transceiver (112) and a processor (114). Elements of the first BS (110) are not, however, limited thereto. The first BS (110) may include more or fewer elements than described above. The processor (114) and the transceiver (112) may be implemented in the form of a single chip.

The processor (114) may control a series of processes for the first BS (110) to be operated according to the embodiments of the disclosure. The processor (114) may control the components of the first BS (110) to transmit or receive signals in a wireless communication system according to embodiments of the disclosure. The processor (114) may be provided in the plural, which may perform the operation of transmitting or receiving signals in the wireless communication system as described above by carrying out a program stored in a memory.

The transceiver (112) may transmit or receive signals to or from the UE (130). The signals to be transmitted to or received from the UE (130) may include control information and data. The transceiver (112) may include an RF transmitter for up-converting the frequency of a signal to be transmitted and amplifying the signal and an RF receiver for low-noise amplifying a received signal and down-converting the frequency of the received signal. This is merely an example, and the elements of the transceiver (112) are not limited to the RF transmitter and RF receiver. The transceiver (112) may receive a signal on a wireless channel and output the signal to the processor (114), and transmit a signal output from the processor (114) on a wireless channel.

The second BS (120) may include a transceiver (122) and a processor (124). Elements of the second BS (120) are not, however, limited thereto. The second BS (120) may include more or fewer elements than described above. The processor (124) and the transceiver (122) may be implemented in the form of a single chip.

The processor (124) may control a series of processes for the second BS (120) to be operated according to the embodiments of the disclosure. The processor (124) may control the components of the second BS (120) to transmit or receive signals in a wireless communication system according to embodiments of the disclosure. The processor (124) may be provided in the plural, which may perform the operation of transmitting or receiving signals in the wireless communication system as described above by executing a program stored in a memory.

The transceiver (122) may transmit or receive signals to or from the UE (130). The signals to be transmitted to or received from the UE (130) may include control information and data. The transceiver (122) may include an RF transmitter for up-converting the frequency of a signal to be transmitted and amplifying the signal and an RF receiver for low-noise amplifying a received signal and down-converting the frequency of the received signal. This is merely an example, and the elements of the transceiver (122) are not limited to the RF transmitter and RF receiver. The transceiver (122) may receive a signal on a wireless channel and output the signal to the processor (124), and transmit a signal output from the processor (124) on a wireless channel.

The UE (130) may include a transceiver (132) and a processor (134). Elements of the UE (130) are not, however, limited thereto. The UE (130) may include more or fewer elements than described above. The processor (134) and the transceiver (132) may be implemented in the form of a single chip.

The processor (134) may control a series of processes for the UE (130) to be operated according to the embodiments of the disclosure. The processor (134) may control the components of the UE (130) to transmit or receive signals in a wireless communication system according to embodiments of the disclosure. The processor (134) may be provided in the plural, which may perform the operation of transmitting or receiving signals in the wireless communication system as described above by carrying out a program stored in a memory.

The transceiver (132) may transmit or receive signals to or from a BS. The signals to be transmitted to or received from the BS may include control information and data. The transceiver (132) may include an RF transmitter for up-converting the frequency of a signal to be transmitted and amplifying the signal and an RF receiver for low-noise amplifying a received signal and down-converting the frequency of the received signal. It is merely an example, and the elements of the transceiver (132) are not limited to the RF transmitter and RF receiver. The transceiver (132) may receive a signal on a wireless channel and output the signal to the processor (134), and transmit a signal output from the processor (134) on a wireless channel.

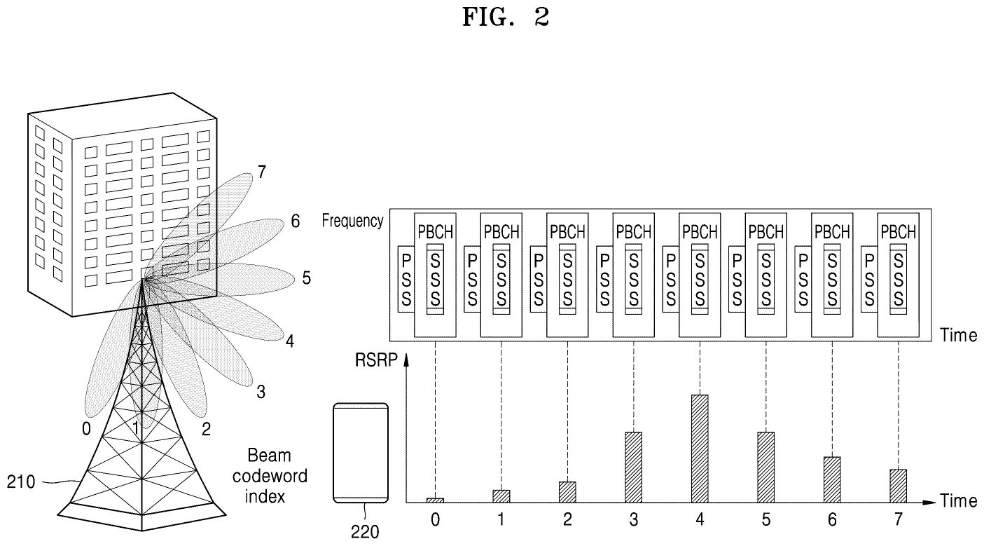

FIG. 2 illustrates a codebook-based beam management method, according to an embodiment.

Referring to FIG. 2, a codebook-based beam management method may be used in a 5G NR system. The codebook-based beam management method may include a beam sweeping procedure and a beam refinement procedure. The beam sweeping procedure may be a procedure in which the BS (210) sequentially transmits synchronization signals to roughly determine the location of the UE 220. In the beam sweeping procedure, the BS (210) may sequentially transmit the synchronization signals to the UE (220). The synchronization signal may be a synchronization signal block (SSB). The synchronization signal may be a signal for providing the UE (220) with synchronization and cell identification information required to start and maintain communication. The synchronization signal may be transmitted based on a codebook. The codebook may be a set of symbols or patterns used to compress data. The codebook may be based on a two-dimensional discrete Fourier transform (2D-DFT).

In the beam sweeping procedure, the UE (220) may give feedback an index of a synchronization signal having a maximum received power intensity among the received synchronization signals to the BS (210). The UE (220) may give feedback the received power intensity of the received synchronization signal to the BS (210). The received power intensity of the received synchronization signal may include reference signals received power (RSRP).

The beam refinement procedure may refer to a procedure for selecting a narrower beam based on the location of the UE (220) that is roughly figured out in the beam sweeping procedure. In the beam refinement procedure, the BS (210) may transmit at least one channel state estimation signal in an approximate direction of the UE (220). The channel state estimation signal may include a channel state information-reference signal (CSI-RS). The channel state estimation signal may be transmitted at certain intervals, and a receiving end may estimate channel state information. In the beam refinement procedure, the BS (210) may receive a measurement report from the UE (220) as a response to the channel state estimation signal. In the beam refinement procedure, the BS (210) may select a narrower beam based on the received measurement report.

The codebook-based beam management method used in the 5G NR system may have a beam quantization error and a heavy pilot overhead in a THz band. The beam quantization error may occur due to a difference between the beam direction and the actual direction of the UE, thus causing beamforming gain degradation and lower communication quality. The heavy pilot overhead may refer to a reduction in data transmission efficiency that is caused by an increase of a proportion of a pilot signal as compared to data transmission. The pilot signal may refer to a signal for channel state estimation. The beam direction and the actual direction of the UE may differ due to a delay time of the pilot signal.

The problems of the codebook-beam management method used in the 5G NR system may be solved by the following embodiments. A location-based beam management method using sensing information will now be described.

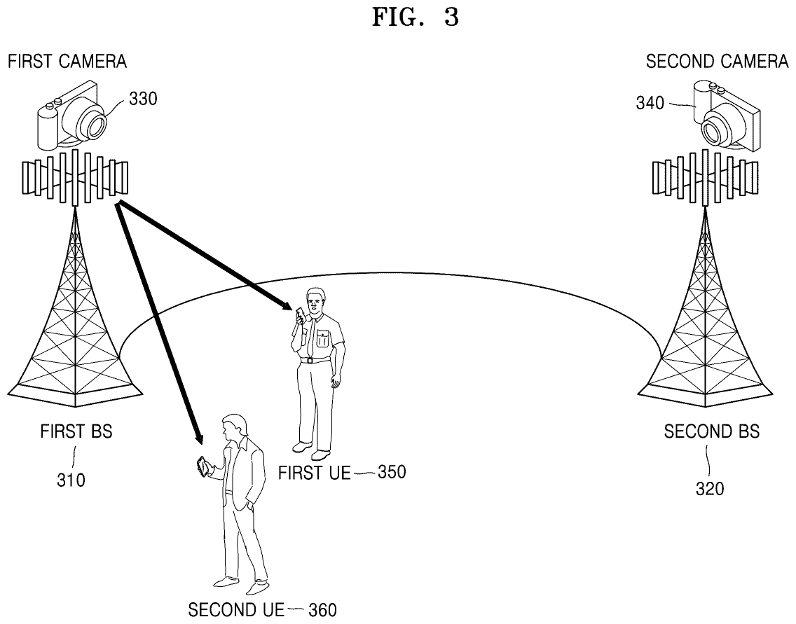

FIG. 3 illustrates a beam management method using sensing information, according to an embodiment.

Referring to FIG. 3, a first BS (310) may use sensing information of a second BS (320) to transmit beams to a first UE (350) and a second UE (360). The first BS (310) may include a first camera (330). It is not, however, limited thereto. The first BS (310) may obtain first sensing information from the first camera (330) installed separately from the first BS (310). The second BS (320) may include a second camera (340). It is not, however, limited thereto. The second BS (320) may obtain second sensing information from the second camera (340) installed separately from the second BS (320). The first BS (310) may receive the second sensing information from the second BS (320).

The first camera (330) and the second camera (340) may capture the first UE (350) and the second UE (360). The first camera (330) and the second camera (340) may include a red green blue (RGB) camera, a light detection and ranging (LiDAR), an infrared (IR) camera, and a light amplification by the stimulated emission of radiation (LASER). It is not, however, limited thereto. The first camera (330) may obtain a first image by capturing the first UE (350) and the second UE (360). The second camera (340) may obtain a second image by capturing the first UE (350) and the second UE (360). The first image may be included in the first sensing information. The second image may be included in the second sensing information.

THz band signals with high frequencies have strong linearity and is thus close to visible light in physical properties, so the transmission energy may be concentrated on a line of sight (LoS). Based on the characteristics, the first BS (310) may use the first sensing information and the second sensing information received from the second BS (320) to estimate locations of the first UE (350) and the second UE (360). The first BS (310) may determine a beamforming vector based on the estimated locations.

A deep learning model may be used to estimate the locations of the first UE (350) and the second UE (360). The deep learning model is a branch of AI and machine learning based on an artificial neural network, and may refer to a technical model used to learn complicated patterns from massive data to provide a solution. The deep learning model may include a convolutional neural network (CNN), long short-term memory models (LSTM) and a vision transformer. With the first sensing information and the second sensing information as inputs, the deep learning model may identify 3D coordinates of the first UE (350) and the second UE (360). The first BS (310) may determine a beamforming vector based on the identified 3D coordinates and transmit beams.

The beam management method using the sensing information uses the sensing information instead of sending the pilot signal for channel estimation, thereby reducing the beam training overhead and power consumption. The beam management method using the sensing information is not affected by a signal-to-noise ratio (SNR), so it may attain high location accuracy and beam focusing gains even in a low SNR area. Furthermore, the beam management method using the sensing information may determine a beamforming vector in the 3D coordinate directions of the estimated UE, thereby reducing the beam quantization error.

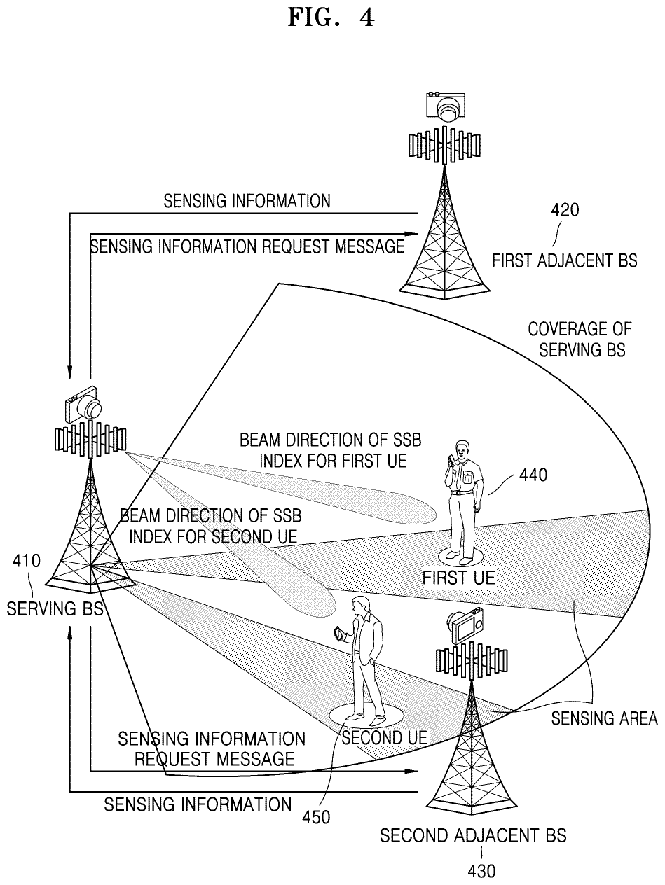

FIG. 4 illustrates a method of transmitting and receiving sensing information, according to an embodiment.

Referring to FIG. 4, a serving BS (410) may obtain sensing information about at least one first object. The serving BS (410) forms a communication network with the UE (130), transmitting and receiving data, and may include the first BS (110). The serving BS (410) may use a camera installed at the serving BS (410) to obtain the sensing information about the at least one first object. It is not, however, limited thereto.

The at least one first object may include a first UE (440) and a second UE (450). It is not, however, limited thereto. The at least one first object may include at least one communication device such as a UE and a vehicle.

The sensing information about the at least one first object may include a class of the object, a sensing area, an information type, an information format, an information exchange interval, and a coverage range. It is not, however, limited thereto. The class of the object may refer to information that may define the object and may be information indicating a class of a communication device, such as whether the object is a UE or a vehicle. The sensing area may refer to information about an area that may be detected by the serving BS (410) through the camera. The information type may include a feature vector or a ray vector. The information format may include a vector size or a quantization level. The information exchange interval may refer to intervals at which to transmit and receive information with adjacent BSs (420, 430). The coverage range may refer to a range of the sensing area that may be detected by the serving BS (410).

The serving BS (410) may transmit at least one synchronization signal to the first UE (440) and the second UE (450). It is not, however, limited thereto. The serving BS (410) may receive, from the first UE (440) and the second UE (450), feedback information including at least one of information about an index of a synchronization signal having the maximum received power intensity among the at least one synchronization signal or information about the received power intensity.

The serving BS (410) may select an adjacent BS (420, 430) based on at least one of the sensing information about the at least one first object or the feedback information. The adjacent BS (420, 430) may include the second BS (120). The serving BS (410) may select an adjacent BS (420, 430) based on information about the coverage range and information about the index of a synchronization signal. The serving BS (410) may receive information about an index of a synchronization signal having the maximum received power intensity among the synchronization signals received by the first UE (440). The serving BS (410) may receive information about an index of a synchronization signal having the maximum received power intensity among the synchronization signals received by the second UE (450). The serving BS (410) may figure out approximate directions of the first UE (440) and the second UE (450) based on the indexes of synchronization signals received from the first UE (440) and the second UE (450). When the first UE (440) and the second UE (450) are located in the sensing coverage range, the serving BS (410) may determine a beamforming vector based on the sensing information.

The serving BS (410) may select an adjacent BS (420, 430). The serving BS (410) may select BSs that are able to perform sensing on an area determined based on the directional information of the at least one first object obtained through the information about the index of the synchronization signal received from the at least one first object and the coverage range of the serving BS (410) as the adjacent BSs (420, 430) that are to receive information.

The serving BS (410) may request the adjacent BS (420, 430) to transmit sensing information. The serving BS (410) may obtain information about the sensing area or coverage range of the adjacent BS (420, 430) in advance. The serving BS (410) may select the adjacent BS (420, 430) having the sensing area and coverage range in which the first UE (440) and the second UE (450) may be detected. The serving BS (410) may transmit a sensing information request message to the adjacent BS (420, 430). The sensing information request message may include the sensing information about the at least one first object. The sensing information request message may be referred to as a first message. The serving BS (410) may transmit the first message including the sensing information about the at least one first object to the adjacent BS (420, 430).

The adjacent BS (420, 430) may obtain sensing information about a second object by using a camera installed at the adjacent BS (420, 430). However, the disclosure is not limited thereto.

The at least one second object may include the first UE (440) and the second UE (450). The at least one second object may include at least one communication device such as a UE and a vehicle.

An image obtained by the adjacent BS (420, 430) through the camera has a large data size, so it may not be easy to transmit the image. The adjacent BS (420, 430) may transmit compressed information to the serving BS (410) including the sensing information about the at least one second object. The sensing information about the at least one second object may include at least one of the number of the detected at least one second object, a feature vector or a ray vector, but is not limited thereto.

The serving BS (410) may receive, from the adjacent BS (420, 430), a second message including the sensing information about the at least one second object as a response to the first message. The adjacent BS (420, 430) may transmit the second message including the sensing information about the at least one second object to the serving BS (410) in response to the sensing information request message.

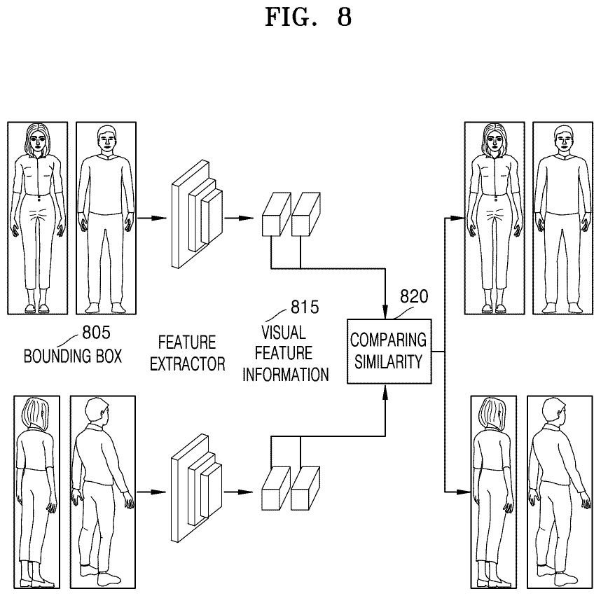

The serving BS (410) may map the at least one first object and the at least one second object based on the sensing information about the at least one first object and the sensing information about the at least one second object. The serving BS (410) may identify at least one UE by mapping the at least one first object and the at least one second object, as will be described in detail with reference to FIG. 8.

The serving BS (410) may transmit information about the mapping of the at least one first object and the at least one second object to the adjacent BS (420, 430). The serving BS (410) may request information about a mapped object only. The serving BS (410) may transmit a sensing information request message including the information about the mapped object to the adjacent BS (420, 430). The information about the mapped object may include only information relating to the mapped object among the sensing information about the at least one first object.

The serving BS (410) may receive sensing information based on information about the mapping from the adjacent BS (420, 430). The adjacent BS (420, 430) may transmit the sensing information based on the information about the mapping to the serving BS (410), including information sensed by the neighboring BS (420, 430) for the mapped object The sensing information based on the information about the mapping may include only information relating to the mapped object among the sensing information about the at least one second object. This may reduce data transmission and reception overhead and increase communication efficiency.

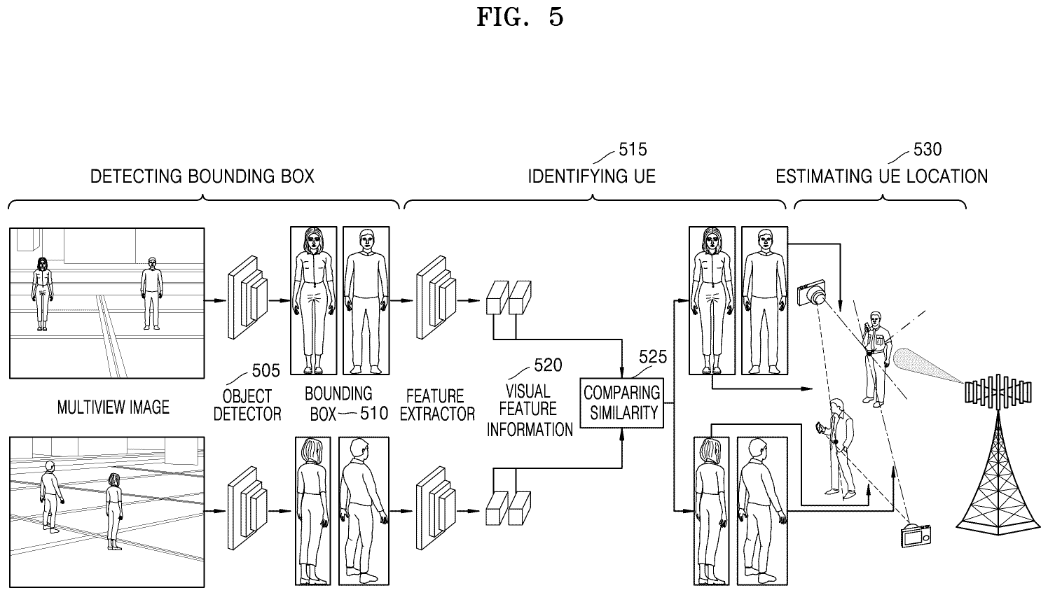

FIG. 5 illustrates a beam management method using sensing information, according to an embodiment.

Referring to FIG. 5, the first BS (110) may detect at least one first object including the at least one UE (130). The first BS (110) may obtain a first image captured by the first BS (110). The first BS (110) may obtain at least one first bounding box (510) for the at least one first object in the first image.

The at least one first object may be detected by obtaining the at least one first bounding box (510) including the at least one UE (130). A bounding box (510) may refer to a minimum rectangular area including the UE (130), but is not limited thereto. The first BS (110) may obtain the at least one first bounding box (510) through an object detector (505) based on a deep learning model. The object detector (505) may refer to a technology to detect a bounding box or an object by using the deep learning model.

The first BS (110) may obtain the first image captured by the first BS (110). The first BS (110) may use the camera installed at the first BS (110) to obtain the first image. The first BS (110) may detect the at least one first bounding box (510) including the at least one UE (130) in the first image through the object detector (505) based on the deep learning model.

The second BS (120) adjacent to the first BS (110) may obtain at least one second bounding box or the at least one second object in the second image obtained by using the camera installed at the second BS (120). The second BS (120) may transmit information about the obtained at least one second bounding box and at least one second object to the first BS (110). The information about the at least one second bounding box and at least one second object obtained by the second BS (120) may be included in the second message. The first BS (120) may receive, from the second BS (120), the information about the at least one second bounding box and the at least one second object obtained by the second BS (120).

A center point, width and height of the at least one first bounding box obtained by the first BS (110) may be included in information about center point, width and height of the first object. A center point, width and height of the at least one second bounding box obtained by the second BS (120) may be included in information about center point, width and height of the second object.

The first BS (110) may identify 515 at least one UE (130) based on the at least one first object and the at least one second object. The first BS (110) may map the at least one first bounding box and the at least one second bounding box. The first BS (110) may identify (515) at least one UE (130) by mapping the at least one first bounding box and the at least one second bounding box.

The first BS (110) may obtain visual feature information (520) of the at least one first object and the at least one second object. The first BS (110) may use contrastive learning based on a deep learning model to obtain the visual feature information (520) of the at least one first object and the at least one second object. The visual feature information (520) may include color, clothing, shape, etc. The contrastive learning may refer to a technology to extract features of two or more pieces of information and determine the similarity (525) by comparing the features.

The first BS (110) may determine visual similarity (525) based on the visual feature information (520) by using the contrastive learning based on the deep learning model. For example, when the first object in the first bounding box is featured by wearing a red dress and blue jeans and the second object in the second bounding box is also featured by wearing a red dress and blue jeans, the visual similarity between the two objects may be determined to be high.

The first BS (110) may map the at least one first object and the at least one second object based on the visual similarity. The first BS (110) may use the deep learning model to map the at least one first object and the at least one second object. The first BS (110) may map the objects with high visual similarity one-to-one as the same object. The mapped objects may be regarded as the same object. The first BS (110) may identify at least one UE (130) by mapping the at least one first object and the at least one second object.

The first BS (110) may estimate a location (530) of the identified at least one UE (130). The first BS (110) may obtain a first directional vector based on the first BS (110) and the at least one first object. The first BS (110) may determine the first directional vector of a first straight line that passes the first camera installed at the first BS (110) and the center point of the first object. The first BS (110) may obtain a second directional vector based on the second BS (110) and the at least one second object. The first BS (110) may determine the second directional vector of a second straight line that passes the second camera installed at the second BS (120) and the center point of the second object.

The first BS (110) may obtain coordinates of the at least one UE (130) based on the first directional vector and the second directional vector. Based on the first directional vector and the second directional vector, the first BS (110) may determine an intersection point of the first straight line and the second straight line. The intersection point of the first straight line and the second straight line may be obtained by using a least square estimator. The first BS (110) may determine the intersection point of the first straight line and the second straight line as the coordinates of the UE (130). The location of the UE (130) may be obtained based on the coordinates of the UE (130). The coordinates of the UE (130) may be represented in 3D coordinates.

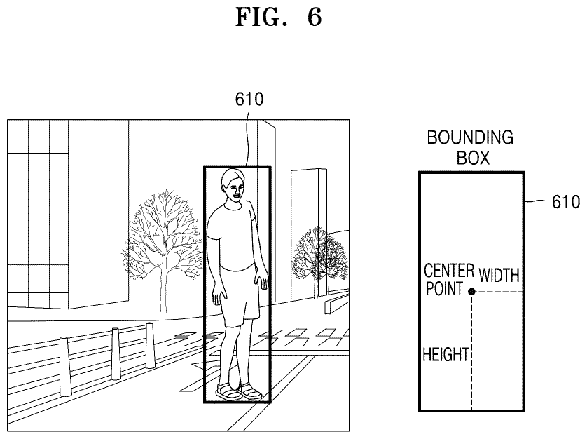

FIG. 6 illustrates a method of detecting the bounding box (610), according to an embodiment.

Referring to FIG. 6, the first BS (110) may detect the at least one first object including the at least one UE (130).

The first BS (110) may obtain the first image captured by the first BS (110). The first BS (110) may use the object detector based on the deep learning model to detect the at least one first bounding box (610) in the first image. The at least one first bounding box (610) may include information about the center point, width and height. The center point of the at least one first bounding box (610) may be regarded as center point of the at least one first object. The first BS (110) may obtain the at least one first bounding box for the at least one first object in the first image.

The first BS (120) may receive, from the second BS (120), information about the at least one second bounding box and the at least one second object. The information received from the second BS (120) may include compressed information such as a feature vector or a ray vector.

The first BS (110) may obtain a set of images through the information received from a plurality of adjacent BSs including the second BS (120). The set of images may be expressed in Equation (1) below.

$$𝒥 = {\{ {I}_{f} \}}_{f = 1}^{N} \qquad ( 1 )$$

In Equation (1), I_{f} is an image from an f-th camera, w and h may indicate width and height of the image.

The first BS (110) may obtain two-dimensional (2D) orthogonal coordinates of an object in the image by using a deep learning model. To do so, a deep learning model comprised of a backbone, a neck and a head may be used. The backbone may extract a feature from the image. The feature may include color, shape, face, etc. The neck may give a weight to the extracted feature so that the head is able to concentrate on required information. The weight may include an edge, a curve, a face, a wall, etc. The head may use the feature given the weight as an input to calculate a confidence score and the size of the bounding box (610). The confidence score may indicate a possibility of the existence of an object. A point having the highest confidence score may be regarded as a pixel where an object is located in the image.

The first BS (110) may find a bounding box set of [symbol] _{F}={B_{k,f}}ₖ₌₁^{M}^{_{f}} from the image I_{f}∈ [symbol] ^{w×h×3} given from camera f by using a deep learning model-based object detector. b_{k,f} is a bounding box of a k-th object from the f-th camera, and M_{f} may indicate the number of UEs (130) detected by the f-th camera. The bounding box (610) may be expressed in Equation (2) below.

$${b}_{k , f} = ( {x}_{k , f}^{I} , {y}_{k , f}^{I} , {w}_{k , f}^{I} , {h}_{k , f}^{I} ) \qquad ( 2 )$$

In Equation (2), the bounding box (610) may include center orthogonal coordinates (x_{k,f}^{I},y_{k,f}^{I}), and width and height (w_{k,f}^{I},h_{k,f}^{I}) of a rectangular area selected from the image. The center point of the bounding box (610) may be used to estimate a location of the UE.

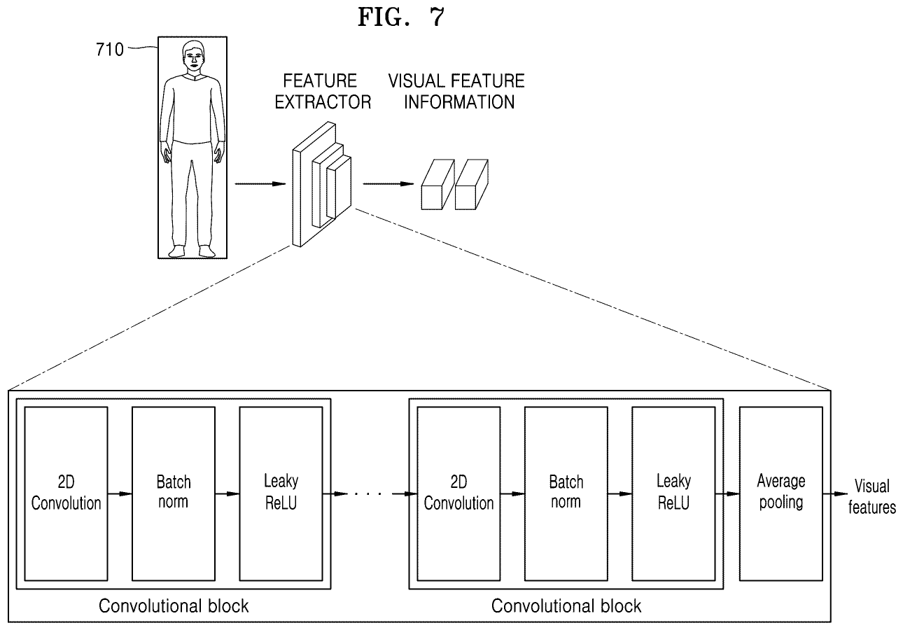

FIG. 7 illustrates a method of extracting visual feature information from a bounding box 710, according to an embodiment.

Referring to FIG. 7, the first BS (110) may obtain visual feature information of the at least one first object and the at least one second object.

The first BS (110) may obtain a list of bounding boxes detected from the perspective of a plurality of adjacent BSs including the second BS (120). The first BS (110) may use deep learning model-based contrastive learning to obtain the visual feature information so as to identify matching bounding box (710) among the bounding boxes (710) for the same UE (130). The visual feature information may include dress color, body shape, etc. The first BS (110) may identify the UE (130) by mapping a pair of bounding boxes (710) with high visual similarity. For example, the first BS may determine that bounding boxes including the same dress color and body shape have high visual similarity. The first BS may map bounding boxes with high visual similarity in pairs, and identify each mapped bounding box as a separate UE. The first BS (110) may use the deep learning model-based contrastive learning to extract a common feature of the same UE (130) and identify the UE (130) based on the visual similarity.

The deep learning model may use I_{f,k}∈ [symbol] ^{w}^{_{k,f}}^{^{J}}^{×h}^{_{k,f}}^{^{I}}^{×3} obtained by cutting a certain area from the image I_{f} based on the bounding box (710) b_{k,f} as an input image. The bounding box b_{k,f} may indicate a spatial range of the k-th UE in the f-th view. The first BS (110) may use a feature extractor to extract visual feature information of the at least one first object and the at least one second object. The feature extractor may include a convolutional neural network (CNN) comprised of multiple convolutional blocks. A convolutional layer may receive a previous layer a^{l-1}∈ [symbol] ^{h}^{^{l−1}}^{×w}^{^{l−1}}^{×d}^{^{l−1}} as an input to output a feature map a^{l}∈ [symbol] ^{h}^{^{l}}^{×w}^{^{l}}^{×d}^{^{l}}. a⁰ may indicate an input image. When an n-th filter of an I-th convolutional layer is denoted as [symbol] ∈ [symbol] and an n-th bias of the I-th convolutional layer is denoted as vₙ^{l}∈ [symbol] ^{d}^{^{l−1}}, an m-th output neuron of an I-th layer of the n-th filter may be expressed in Equation (3) below.

$${a}_{x , y}^{l} = f ( {\sum }_{i = 1}^{{h}^{l - 1}} {\sum }_{i = 1}^{{w}^{l - 1}} {\sum }_{k = 1}^{{d}^{l - 1}} {𝒦}_{i , j , k}^{( n )} {a}_{x + i - 1 , y + j - 1 , k}^{l - 1} {v}_{n}^{l} ) \qquad ( 3 )$$

In Equation (3), f (x)=max (0.1x, x) may refer to a leaky rectified linear unit (leaky ReLU), which is one of activation functions. A visual feature may be extracted from an output vector a^{l}∈ [symbol] ^{h}^{^{l}}^{×w}^{^{l}}^{×d}^{^{l}} of the last convolutional layer. As the output may have various spatial sizes, a visual feature of an input image may be obtained by applying average pooling as in Equation (4) below.

$$a = \frac{1}{{w}^{l} {h}^{l}} {\sum }_{i = 1}^{{w}^{l}} {\sum }_{= 1}^{{h}^{l}} {a}_{i , j}^{l} \qquad ( 4 )$$

In Equation (4), the feature extractor may be used for the input image I_{f,k} to obtain a visual feature vector a_{f,k}.

FIG. 8 illustrates a method of mapping a bounding box, according to an embodiment.

Referring to FIG. 8, the first BS (110) may determine visual similarity (820) based on the visual feature information (815) obtained from a feature extractor 810. The first BS (110) may map the at least one first object and the at least one second object based on the visual similarity (820). The first BS (110) may identify at least one UE based on the at least one first object and the at least one second object.

The first BS (110) may determine the visual similarity (820) by using the contrastive learning based on a deep learning model. The contrastive learning may learn the expression of images such that the same UEs (130) are expressed as being close to each other and different UEs (130) are expressed as being distant. Given a pair of bounding boxes taken from views f and g, The contrastive learning may minimize cosine similarity when the bounding boxes (805) belong to different UEs and maximize cosine similarity when the bounding boxes (805) belong to the same UE, as expressed in Equation (5) below.

$$L ( {b}_{k , f} , {b}_{j , g} ) = ( 1 - 2 * 1 ( k , j ) ) {s}_{( k , f ) , ( j , g )} \qquad ( 5 )$$

In Equation (5), 1 (k,j) is an indicator function, which returns 1 when k and j are the same UEs (130) and returns 0 otherwise. s_{(k,f)(j,g)} may refer to a similarity measurement between the k-th UE (camera f) and the j-th UE (camera g) of visual features a_{k,f} and a_{j,g}. The visual similarity (820) may be calculated by using cosine similarity, as shown in Equation (6) below.

$${s}_{( k , f ) ( j , g )} = \frac{{a}_{k , f}^{τ} {a}_{j , g}}{‖ {a}_{k , f} ‖ ‖ {a}_{j , g} ‖} \qquad ( 6 )$$

By applying the contrastive learning, the deep learning model may learn visual features that help identify the at least one UE (130) between images.

In a UE pair with high visual similarity, the two bounding boxes may have the highest similarity as compared to other pairs. Bounding boxes from different BSs may be paired, so the identifying of UEs (130) may be regarded as a matter of bipartite matching. Bounding box lists of UEs (130) detected from the images f and g may be denoted as Bf and B_{g}, respectively. The two sets may be assumed to have a same number of UEs (130), i.e., M_{f}=M_{g}=M. The following expressions may be given to find minimum cost bipartite matching between the two sets, as shown in Equation (7) below.

$$\hat{σ} = {arg max}_{σ ∈ {Δ}_{M}} {\sum }_{k}^{M} ( 1 - {s}_{( k , f ) ( {σ ( k )}_{, g} )} ) \qquad ( 7 )$$

In Equation (7), σ(k) may indicate an image f-to-image g bounding box index mapping function. The optimal allocation may be found by using the Hungarian algorithm. In a multi-view system having two or more cameras, identifying the UEs (130) may be performed on every image pair.

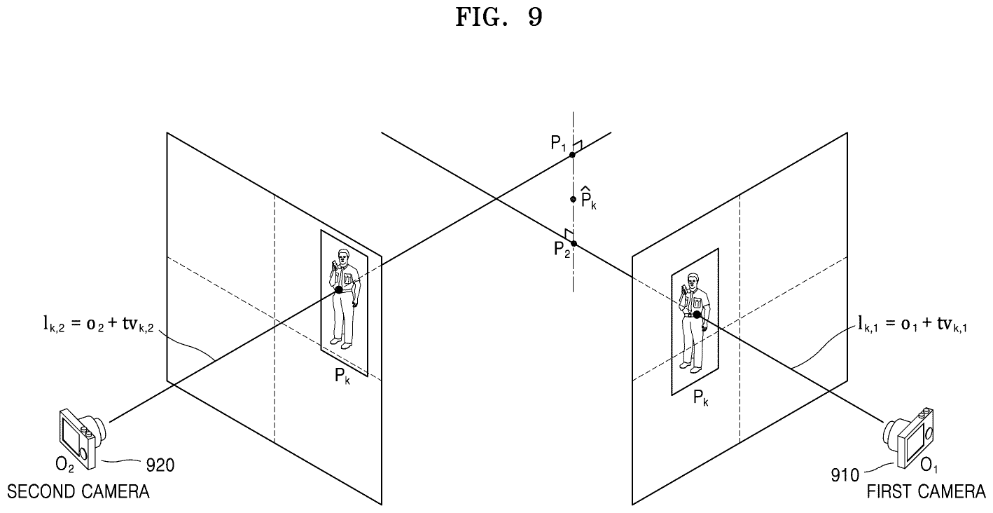

FIG. 9 illustrates a method of estimating a location of a UE, according to an embodiment.

Referring to FIG. 9, the first BS (110) may obtain a first directional vector based on the first BS (110) and the at least one first object. The first BS (110) may obtain a second directional vector based on the second BS (110) and the at least one second object. The first BS (110) may obtain coordinates of the at least one UE (130) based on the first directional vector and the second directional vector. The first BS (110) may use the coordinates of the at least one UE (130) to estimate the location of the at least one UE 130.

The first BS (110) may obtain a first straight line that passes a first camera (910) of the first BS (110) and center coordinates (u1, v1) of a first object. The first BS (110) may obtain a second straight line that passes a second camera (920) of the second BS (120) and center coordinates (u2, v2) of a second object. The first BS (110) may determine an intersection point of the first straight line and the second straight line. The first BS (110) may estimate the intersection point of the first straight line and the second straight line as the location of the UE (130).

When the first straight line and the second straight line does not intersect but skew, center point P of a straight line that passes points P1 and P2 on the first and second straight lines at a minimum distance may be estimated as the location of the UE (130).

To obtain 3D coordinates of the UE (130), a straight line that passes the center coordinates of the UE (130) from each camera may be determined. It is assumed that the location o_{f}=[o_{f,x}o_{f,y}o_{f,z}]^{T} of the camera, rotation angles θ_{f,x}, θ_{f,y} and θ_{f,z} of the respective axes are known. Rotation on each axis may be expressed in the following matrix:

$$\begin{matrix}{R}_{f , x} = [ \begin{matrix}cos {θ}_{f , x} & - sin {θ}_{f , x} & 0 \\ cos {θ}_{f , x} & cos {θ}_{f , x} & 0 \\ 0 & 0 & 1 \\ & & \end{matrix} ] \\ {R}_{f , y} = [ \begin{matrix}1 & 0 & 0 \\ 0 & cos {θ}_{f , y} & sin {θ}_{f , y} \\ 0 & sin {θ}_{f , y} & cos {θ}_{f , y} \\ & & \end{matrix} ] \\ {R}_{f , z} = [ \begin{matrix}cos {θ}_{f , z} & 0 & - sin {θ}_{f , z} \\ 0 & 1 & 0 \\ sin {θ}_{f , z} & 0 & cos {θ}_{f , z} \\ & & \end{matrix} ]\end{matrix}$$

The rotation may be denoted as a single matrix R_{f}=R_{f,x}R_{f,y}R_{f,z}. It may be assumed that an internal parameter matrix

$${K}_{f} = [ \begin{matrix}α & 0 & {c}_{x} \\ 0 & α & {c}_{y} \\ 0 & 0 & 1 \\ & & \end{matrix} ]$$

of the camera is known. α is a focal distance of the camera, and cₓ and c_{y} are values obtained by dividing the resolution of the camera in half. When the directional vector is denoted as v_{k,f}, a straight line that passes the k-th UE from the camera f may be linearly expressed in a three-dimensional (3D) space as shown in Equation (8) below.

$${1}_{k , f} = {o}_{f} + t {v}_{k , f} \qquad ( 8 )$$

To obtain the directional vector v_{k,f} in the camera coordinate system, a directional vector may be determined in the camera coordinate system. The center pixel in the image is expressed in Equation (9) below.

$${p}_{k , f}^{image} = {[ {x}_{k , f} , {y}_{k , f} , 1 ]}^{T} \qquad ( 9 )$$

Using the center pixel in the image, the directional vector in the camera coordinate system may be determined as in Equation (10) below.

$${v}_{k , f}^{c a m} = {p}_{k , f}^{image} {K}_{f}^{- 1} \qquad ( 10 )$$

A directional vector of the world coordinate system may be obtained by inversely applying the three rotations as in Equation (11) below.

$${v}_{k , f} = {v}_{k , f}^{c a m} {R}_{f}^{- 1} \qquad ( 11 )$$

After beams are formed, the location of the UE 130 may be obtained with intersections of the beams. \hat{p}ₖ is on the line l_{k,f}=o_{f}+tv_{k,f}, so a result of projecting \hat{p}ₖ−o_{f} onto v_{k,f} is equal to \hat{p}ₖ−o_{f}. Accordingly, the beam may be expressed as in Equation (12) below.

$$( I - {V}_{k , f} ) ( {\hat{p}}_{k} - {o}_{f} ) = 0 \qquad ( 12 )$$

In Equation (12), I is an identity matrix, and V_{k,f}=v_{k,f} (v_{k,f}^{T}v_{k,f})⁻¹ v_{k,f}^{T} is a projected matrix onto the directional vector v_{k,f}.

An overdetermined linear system including N equations may be configured by collecting straight lines from the camera f (f=1, . . . , N). This system may be expressed as follows:

$$G {\hat{p}}_{k} = b , where G = [ \begin{matrix}I - {V}_{k , 1} \\ ⋮ \\ I - {V}_{k , N}\end{matrix} ] , b = [ \begin{matrix}( I - {V}_{k , 1} ) {o}_{1} \\ ⋮ \\ ( I - {V}_{k , N} ) {o}_{N}\end{matrix} ] .$$

A least square solution of the overdetermined linear system may be calculated as in Equation (13) below.

$${\hat{p}}_{k} = {( {G}^{T} G )}^{- 1} {G}^{T} b \qquad ( 13 )$$

As described above, a location of the at least one UE (130) may be estimated by obtaining 3D coordinates of the at least one UE (130). The first BS (110) may determine a beamforming vector based on the estimated location.

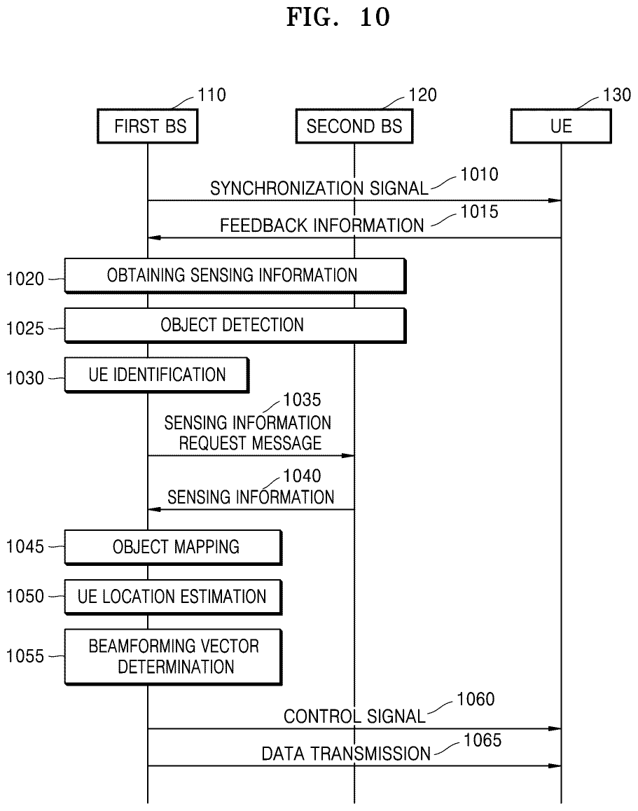

FIG. 10 illustrates a beam management method using sensing information, according to an embodiment.

Referring to FIG. 10, in step 1010, the first BS (110) may transmit at least one synchronization signal to the at least one UE (130). The at least one synchronization signal may be at least one SSB. The first BS (110) may transmit the at least one synchronization signal periodically.

In step 1015, the first BS (110) may receive, from the at least one UE (130), feedback information including at least one of information about an index of a synchronization signal having the maximum received power intensity among the at least one synchronization signal or information about the received power intensity. The feedback information may include a CSI report. The information about the index of the synchronization signal having the maximum received power intensity may include an SSB index. The information about the received power intensity may include RSRP. The at least one UE (130) may transmit, to the first BS (130), the feedback information including at least one of the information about an index of a synchronization signal having the maximum received power intensity among the at least one synchronization signal or the information about the received power intensity.

In step 1020, the first BS (110) and the second BS (120) may obtain sensing information including at least one first image captured by a first camera installed at the first BS (110). The sensing information may include at least one second image captured using a second camera installed at the second BS (120). The first BS (110) and the second BS (120) may periodically capture a sensing area to obtain the first image and the second image.

In step 1025, the first BS (110) and the second BS (120) may detect an object. The first BS (110) may detect at least one first object including the at least one UE (130). The second BS (120) may detect at least one second object including the at least one UE (130). The first BS (110) and the second BS (120) may detect the first object and the second object based on the first image and the second image. The first BS (110) and the second BS (120) may use a deep learning model-based object detector to detect an object. The first BS (120) and the second BS (120) may obtain at least one first bounding box and the at least one second bounding box by detecting the object. The bounding box may refer to a minimum rectangular area including the at least one UE (130).

The first BS (110) may allocate a wireless identification number to at least one object. The wireless identification number may include a cell radio network temporary identifier (C-RNTI). The first BS 110 may allocate the wireless identification number based on the feedback information and the information about the bounding box. The first BS (110) may allocate the ID to an object present in a direction detected by comparing directional information indicated by the SSB index and directional information of the bounding box.

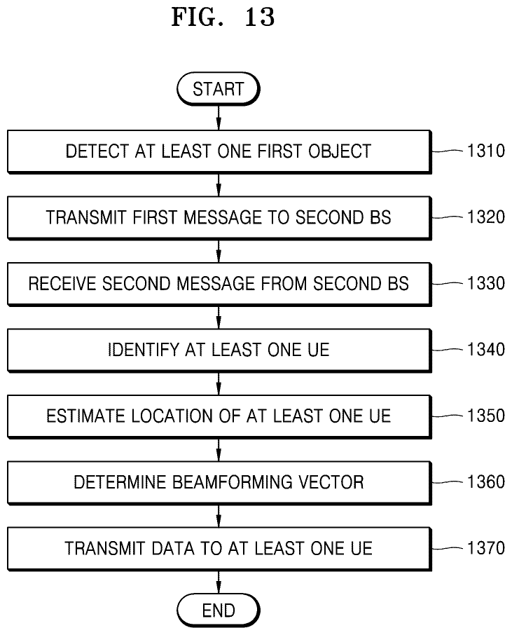

In step 1030, the first BS (110) may identify a UE by allocating the ID to the object. The first BS (110) may determine whether a line of sight (LoS) is a main path. When detecting the first object for the at least one UE (130) in the direction indicated by the SSB index, the first BS (110) may determine that the LoS is the main path. When failing to detect the first object for the at least one UE (130) in the direction indicated by the SSB index, the first BS (110) may determine that none line of sight (NLoS) is the main path. When NLOS is determined to be the main path, the first BS (110) may operate according to a codebook-based beam management method. This will be described in detail later with reference to FIG. 13. When LOS is determined to be the main path, the first BS (110) may operate as follows.

The first BS (110) may select the second BS (120) based on at least one of the sensing information about the at least one first object or the feedback information. The first BS (110) may select the second BS (120) as an adjacent BS. The first BS (110) may select the adjacent BS to receive information about the at least one UE (130). The first BS (110) may select the adjacent BS to receive information about an object. The adjacent BS may transmit the information about the object including the at least one UE (130) to the first BS (110). The first BS (110) may select the second BS (120) as an adjacent BS based on information about a coverage range of the first BS (110) and the information about the SSB index. The first BS (110) may select BSs that are able to sense the at least one UE (130) as adjacent BSs, based on the directional information obtained through the SSB index and an area determined to be the coverage range of the first BS (110).

In step 1035, the first BS (110) may transmit a first message including the sensing information about the at least one first object to the second BS (120). The sensing information about the at least one first object may include a class of the object, a sensing area, an information type, an information format, an information exchange interval, and a coverage range. The first message may include a sensing information request message.

In step 1040, the first BS (110) may receive, from the second BS (120), a second message including the sensing information about the at least one second object as a response to the first message. The sensing information about the at least one second object may include at least one of the number of the at least one second object detected by the second BS (120), a feature vector or a ray vector. The second message may refer to the sensing information. The second BS (120) may transmit, to the first BS (110), the second message including the sensing information about the at least one second object as a response to the first message.

When the index of the synchronization signal having the maximum received power intensity is identical for all the at least one UE, the first BS (110) may distinguish the at least one UE (130) by using at least one of information about the received power intensity or the sensing information about the at least one second object. An occasion when an SSB index is the same for the at least one UE (130) may refer to when the at least one UE (130) lies on the same line, yet at different distances from the perspective of the first BS (110). RSRPs transmitted by the at least one UE (130) may be different. The first BS (110) may determine a difference in distance between the at least one UE (130) and the first BS (110) based on the information about the received power intensity. The first BS (110) may use the sensing information about the second object to obtain a distance to the at least one UE (130) from the first BS (110). The first BS (110) may distinguish the at least one UE (130) based on the RSRP and the distance to the at least one UE (130) from the first BS (110).

In step 1045, the first BS (110) may map the at least one first object and the at least one second object by mapping the at least one first bounding box and the at least one second bounding box. The first BS (110) may obtain visual feature information of the at least one first object and the at least one second object. The first BS (110) may obtain the visual feature information by using a deep learning model-based feature extractor. The first BS (110) may determine visual similarity based on the visual feature information. The first BS (110) may determine the visual similarity by comparing visual feature information by using the deep learning model-based contrastive learning. The first BS (110) may map the at least one first object and the at least one second object based on the visual similarity. The first BS (110) may identify the at least one UE (130) based on the at least one first object and the at least one second object. The first BS (110) may identify the at least one UE (130) by mapping the at least one first object and the at least one second object.

In step 1050, the first BS (110) may estimate a location of the identified at least one UE (130). The first BS (110) may obtain a first directional vector based on the first BS (110) and the at least one first object based on a first straight line that connects the first camera installed at the first BS (110) to the center point of the at least one first object. The first BS (110) may obtain a second directional vector based on the second BS (120) and the at least one second object. The first BS (110) may obtain the second directional vector based on a second straight line that connects the second camera installed at the second BS (120) to the center point of the at least one second object. The first BS (110) may obtain the second directional vector based on information included in the second message. The first BS (110) may obtain coordinates of the at least one UE (130) based on the first directional vector and the second directional vector. The first BS (110) may obtain 3D coordinates of an intersection point of the first straight line and the second straight line. The first BS (110) may estimate the 3D coordinates of the intersection point of the first straight line and the second straight line as the position of the UE (130).

In step 1055, the first BS (110) may determine a beamforming vector based on the estimated location. The first BS (110) may use the feedback information to obtain an SSB index at which the RSRP has a maximum value. The first BS (110) may identify the at least one UE (130) by comparing the identified location of the at least one UE (130) with the SSB index. The first BS (110) may use the location information obtained by identifying the at least one UE (130) to determine the beamforming vector for the at least one UE (130). Channel vectors of the at least one UE (130) may be asymptotically orthogonal to each other when there are a large number of antennas. Interference caused by beams toward where there are the at least one UEs (130) may be ignored. The beamforming vector may be determined as in Equation (14) below.

$${W}^{*} = \frac{1}{K} [ a ( {\hat{θ}}_{1} , {\hat{φ}}_{1} ) , … , a ( {\hat{θ}}_{K} , {\hat{φ}}_{K} ) ] \qquad ( 14 )$$

In Equation (14), a (\hat{θ}ₖ,\hat{φ}ₖ) may indicate an array response vector. K may indicate the number of users belonging to the total serving BSs. \hat{θ}ₖ and \hat{φ}ₖ may indicate azimuth and elevation.

In step 1060, the first BS (110) may transmit a control signal to the at least one UE (130). The control signal may include information ordering not to estimate and report channel information. The at least one UE (130) may not transmit a CSI report to the first BS (110).

In step 1065, the first BS (110) may transmit data to the at least one UE (130) based on the determined beamforming vector. By forming beams and transmitting data based on the location of the UE (130) estimated using the sensing information, beam training overhead and power consumption may be reduced and high location accuracy and beam focusing gain may be attained even in a low SNR area.

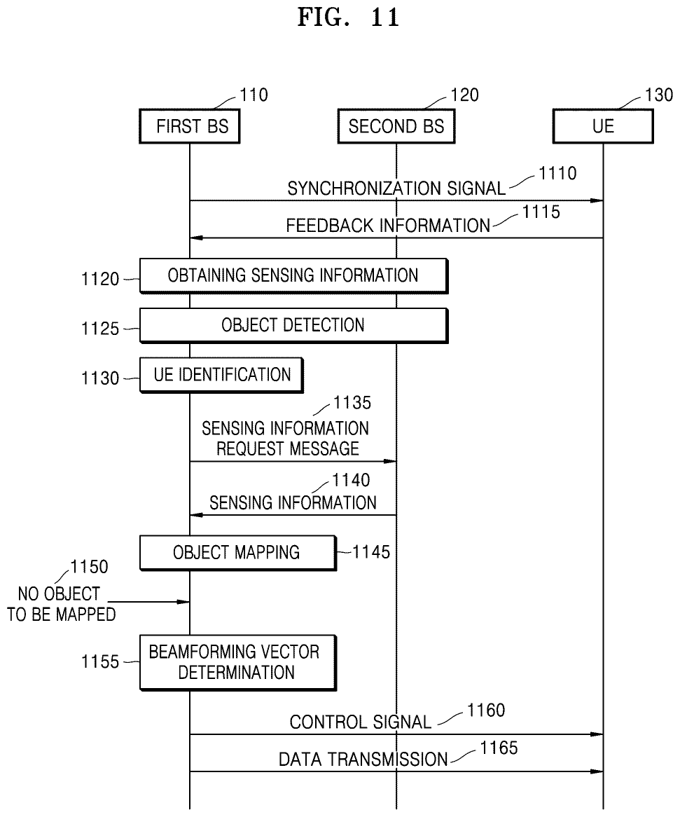

FIG. 11 illustrates a beam management method when there is no bounding box to be mapped, according to an embodiment.

Descriptions overlapping with FIG. 10 will not be repeated.

Referring to FIG. 11, in step 1110, the first BS (110) may transmit at least one synchronization signal to the at least one UE (130). In step 1115, the first BS (110) may receive, from the at least one UE (130), feedback information including at least one of information about an index of a synchronization signal having the maximum received power intensity among the at least one synchronization signal or information about the received power intensity. In step 1120, the first BS (110) and the second BS (120) may obtain sensing information. In step 1125, the first BS (110) and the second BS (120) may detect an object. In step 1130, the first BS (110) may identify a UE. In step 1135, the first BS (110) may transmit a first message including the sensing information about the at least one first object to the second BS (120). In step 1140, the first BS (110) may receive, from the second BS (120), a second message including the sensing information about the at least one second object as a response to the first message. In step 1145, the first BS (110) may map the at least one first object and the at least one second object.

In step 1150, the first BS (110) may determine a beamforming vector based on the sensing information about the at least one first object when there is no second object mapped to the at least one first object. The occasion when there is no second object mapped to the at least one first object may correspond to an occasion when the second BS (120) fails to detect the at least one second object mapped to the at least one first object. The second BS (120) may not detect the at least one second object in the second image captured by the second camera installed at the second BS (120). The at least one second object detected in the second image may be different from the at least one first object.

In step 1155, the first BS (110) may determine a beamforming vector based on the sensing information about the at least one first object. When the first BS (110) is unable to determine the 3D coordinates of the at least one UE (130) based on the sensing information received from the second BS (120), the first BS (110) may generate the beamforming vector in a direction of the at least one UE (130) included in the sensing information about the first object. The first BS (110) may use the sensing information about the first object to obtain information about the direction of the at least one UE (130). The first BS (110) may use the sensing information about the first object to obtain a first directional vector based on the first straight line that passes the first camera and the center point of the at least one UE (130). The first BS (110) may determine a beamforming vector based on the first directional vector. The first BS (110) may transmit data to the at least one UE (130) based on the determined beamforming vector.

In step 1160, the first BS (110) may transmit a control signal to the at least one UE (130). In step 1165, the first BS (110) may transmit data to the at least one UE (130) based on the determined beamforming vector.

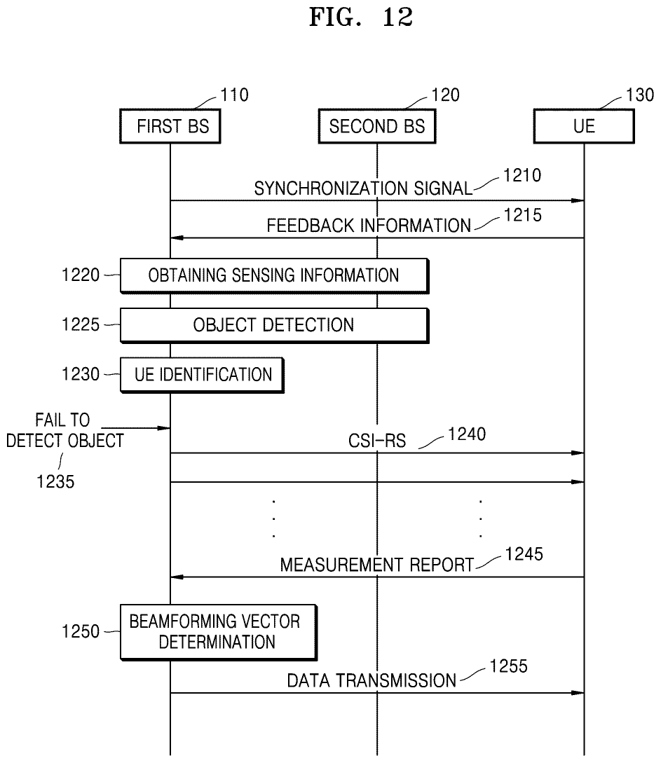

FIG. 12 illustrates a beam management method when no bounding box is detected, according to an embodiment.

Descriptions overlapping with FIG. 10 will not be repeated.

Referring to FIG. 12, in step 1210, the first BS (110) may transmit at least one synchronization signal to the at least one UE (130). In step 1215, the first BS (110) may receive, from the at least one UE (130), feedback information including at least one of information about an index of a synchronization signal having the maximum received power intensity among the at least one synchronization signal or information about the received power intensity. In step 1220, the first BS (110) and the second BS (120) may obtain sensing information. In step 1225, the first BS (110) and the second BS (120) may detect an object. In step 1230, the first BS (110) may identify a UE.

In step 1235, the first BS (110) may determine a beamforming vector based on at least one channel state estimation signal when the at least one first object is not detected for the at least one UE (130, which may correspond to when the first object is not detected in an SSB index direction in the first image. The at least one first object may not be detected because the at least one UE (130) is blocked by e.g., an obstacle from a viewpoint of the first camera installed at the first BS (110). The first BS (110) may operate according to a codebook-based beam management method when the at least one first object is not detected for the at least one UE (130).

In step 1240, the first BS (110) may transmit at least one channel state estimation signal to the at least one UE (130). The channel state estimation signal may include a CSI-RS. The first BS (110) may allow the at least one UE (130) to estimate a state of the channel by transmitting the at least one channel state estimation signal, and may select narrower beams to the location of the at least one UE (130).

In step 1245, the first BS (110) may receive a measurement report from the at least one UE (130). The measurement report may include channel information estimated by the at least one UE (130) based on the channel state estimation signal. The at least one UE (130) may transmit the measurement report to the first BS (110).

In step 1250, the first BS (110) may determine a beamforming vector based on the at least one channel state estimation signal. The first BS (110) may estimate a location of the at least one UE (130) based on the measurement report. The first BS (110) may select a narrower beam based on the measurement report. The first BS (110) may determine a beamforming vector based on the at least one channel state estimation signal and the measurement report.

In step 1255, the first BS (110) may transmit data to the at least one UE (130) based on the determined beamforming vector.

FIG. 13 illustrates a beam management method using sensing information, according to an embodiment.

Referring to FIG. 13, in step 1310, the first BS (110) may detect at least one first object including the at least one UE (130). The first BS (110) may obtain the first image captured by the first BS (110). The first BS (110) may obtain the at least one first bounding box for the at least one first object in the first image.

In step 1320, the first BS (110) may transmit a first message including the sensing information about the at least one first object to the second BS (120). The first message may be a sensing information request message.

In step 1330, the first BS (110) may receive, from the second BS (120), a second message including the sensing information about the at least one second object as a response to the first message.

In step 1340, the first BS (110) may identify at least one UE (130) based on the at least one first object and the at least one second object. The first BS (110) may obtain visual feature information of the at least one first object and the at least one second object. The first BS (110) may determine visual similarity based on the visual feature information. The first BS (110) may map the at least one first object and the at least one second object based on the visual similarity.

In step 1350, the first BS (110) may estimate a location of the identified at least one UE. The first BS (110) may obtain a first directional vector based on the first BS (110) and the at least one first object. The first BS (110) may obtain a second directional vector based on the second BS (120) and the at least one second object. The first BS (110) may obtain coordinates of the at least one UE (130) based on the first directional vector and the second directional vector.

In step 1360, the first BS (110) may determine a beamforming vector based on the estimated location.

In step 1370, the first BS (110) may transmit data to the at least one UE (130) based on the determined beamforming vector.

Methods according to the claims of the disclosure or the embodiments of the disclosure described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a local area network (LAN), a wide LAN (WLAN), or a storage area network (SAN), or a combination thereof. The storage device may be connected to an apparatus performing the embodiments of the disclosure through an external port. In addition, a separate storage device in the communication network may be connected to the apparatus performing the embodiments of the disclosure.

Each block and combination of the blocks of a flowchart may be performed by computer program instructions. The computer program instructions may be loaded onto a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-executable or computer-readable memory that may direct the computers or other programmable data processing apparatus to function in a particular manner, such that the instructions stored in the computer-executable or computer-readable memory may produce an article of manufacture including instruction means that perform the functions specified in the flowchart blocks(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

Furthermore, each block may represent a part of a module, segment, or code including one or more executable instructions to perform particular logic function(s). It is noted that the functions described in the blocks may occur out of order in some alternative embodiments. Two successive blocks may be performed substantially at the same time or in reverse order depending on the corresponding functions.

Herein, a component is represented in a singular or plural form. It should be understood, however, that the singular or plural representations are selected appropriately according to the situations presented for convenience of explanation, and the disclosure is not limited to the singular or plural form of the component. The component expressed in the plural form may also imply the singular form, and vice versa.

What is claimed is:

1. A method, performed by a first base station (BS), for beam management in a wireless communication system, the method comprising:
detecting at least one first object including at least one user equipment (UE);
transmitting, to a second BS, a first message including sensing information about the at least one first object;
receiving, as a response to the first message, from the second BS, a second message including sensing information about at least one second object;
identifying the at least one UE based on the at least one first object and the at least one second object;
estimating a location of the identified at least one UE;
determining a beamforming vector based on the estimated location; and
transmitting data, to the at least one UE, based on the determined beamforming vector.

2. The method of claim 1, further comprising:
transmitting, to the at least one UE, at least one synchronization signal; and
receiving, from the at least one UE, feedback information including at least one of information about an index of a synchronization signal having a maximum received power intensity among the at least one synchronization signal or information about the received power intensity.

3. The method of claim 2, further comprising:
in case that the index of the synchronization signal having the maximum received power intensity is identical for all the at least one UE, distinguishing the at least one UE by using at least one of the information about the received power intensity or the sensing information about the at least one second object.

4. The method of claim 1, further comprising:
in case that there is no at least one second object mapped to the at least one first object, determining the beamforming vector based on the sensing information about the at least one first object.

5. The method of claim 1, further comprising:
in case that the at least one first object is not detected for the at least one UE, determining the beamforming vector based on at least one channel state estimation signal.

6. The method of claim 1, wherein the detecting of the at least one first object comprises:
obtaining a first image captured by the first BS; and
obtaining at least one bounding box for the at least one first object in the first image.

7. The method of claim 1, wherein identifying the at least one UE comprises:
obtaining visual feature information of the at least one first object and the at least one second object;
determining a visual similarity based on the visual feature information; and
mapping the at least one first object and the at least one second object based on the visual similarity.

8. The method of claim 1, wherein estimating the location of the identified at least one UE comprises:
obtaining a first directional vector based on the first BS and the at least one first object;
obtaining a second directional vector based on the second BS and the at least one second object; and
obtaining coordinates of the at least one UE based on the first directional vector and the second directional vector.

9. The method of claim 7, further comprising:
transmitting, to the second BS, information about mapping the at least one first object and the at least one second object; and
receiving, from the second BS, sensing information based on the information about the mapping.

10. The method of claim 2, further comprising:
selecting the second BS based on at least one of the sensing information about the at least one first object or the feedback information.

11. A first base station (BS) for managing beams based on sensing information in a wireless communication system, the first BS comprising:
a transceiver; and
at least one processor coupled to the transceiver,
wherein the at least one processor is configured to:
detect at least one first object including at least one user equipment (UE),
transmit, to a second BS, a first message including sensing information about the at least one first object,
receive, as a response to the first message, from the second BS, a second message including sensing information about at least one second object,
identify the at least one UE based on the at least one first object and the at least one second object,
estimate a location of the identified at least one UE,
determine a beamforming vector based on the estimated location, and
transmit data, to the at least one UE, based on the determined beamforming vector.

12. The first BS of claim 11,
wherein the at least one processor is further configured to:
transmit, to the at least one UE, at least one synchronization signal, and
receive, from the at least one UE, feedback information including at least one of information about an index of a synchronization signal having a maximum received power intensity among the at least one synchronization signal or information about the received power intensity.

13. The first BS of claim 12,
wherein the at least one processor is further configured to,
in case that the index of the synchronization signal having the maximum received power intensity is identical for all the at least one UE, distinguish the at least one UE by using at least one of the information about the received power intensity or the sensing information about the at least one second object.

14. The first BS of claim 11,
wherein the at least one processor is further configured to
in case that there is no at least one second object mapped to the at least one first object, determine the beamforming vector based on the sensing information about the at least one first object.

15. The first BS of claim 11,
wherein the at least one processor is further configured to
in case that the at least one first object is not detected for the at least one UE, determine the beamforming vector based on at least one channel state estimation signal.

16. The first BS of claim 11,
wherein the at least one processor is configured to
obtain a first image captured by the first BS, and
obtain at least one bounding box for the at least one first object in the first image.

17. The first BS of claim 11,
wherein the at least one processor is configured to
obtain visual feature information of the at least one first object and the at least one second object,
determine a visual similarity based on the visual feature information, and
map the at least one first object and the at least one second object based on the visual similarity.

18. The first BS of claim 11,
wherein the at least one processor is configured to
obtain a first directional vector based on the first BS and the at least one first object,
obtain a second directional vector based on the second BS and the at least one second object, and
obtain coordinates of the at least one UE based on the first directional vector and the second directional vector.

19. The first BS of claim 17,
wherein the at least one processor is further configured to
transmit, to the second BS, information about the mapping of the at least one first object and the at least one second object, and
receive, from the second BS, sensing information based on the information about the mapping.

20. The first BS of claim 12,
wherein the at least one processor is further configured to
select the second BS based on at least one of the sensing information about the at least one first object or the feedback information.
